(19) United States
(12) Patent Application Publication
(10) Pub. No.: US 2026/0145276 A1
(43) Pub. Date: May 28, 2026

(54) SUBSTRATE MANUFACTURING METHOD

(71) Applicant: DISCO CORPORATION, Tokyo (JP)

(72) Inventor: Haruna YANO, Tokyo (JP)

(21) Appl. No.: 19/372,581

(22) Filed: Oct. 29, 2025

(30) Foreign Application Priority Data
Nov. 22, 2024 (JP) 2024-204194

(51) Int. Cl. B23K 26/53; B23K 26/08; B23K 101/40

(52) U.S. Cl. CPC B23K 26/53; B23K 26/0853; B23K 2101/40

(57) ABSTRACT

A method of manufacturing a substrate from an ingot having a cylindrical shape includes: relatively rotating the ingot and measurement light about a rotation axis passing through a center of the ingot while irradiating a side surface of the ingot with the measurement light, and detecting a position of a flat surface formed on the side surface of the ingot based on a change in an amount of measurement light received reflected by the side surface; forming a separation layer inside the ingot by positioning, inside the ingot, a focal point of a laser beam having a wavelength that passes through a material constituting the ingot and by relatively moving the ingot and the focal point in a predetermined direction; and separating the substrate from the ingot starting from the separation layer.

### CROSS-REFERENCE TO RELATED APPLICATION(S)

The present application claims priority to and incorporates by reference the entire contents of Japanese Patent Application No. 2024-204194 filed in Japan on Nov. 22, 2024.

### BACKGROUND

The present disclosure relates to a substrate manufacturing method.

In a manufacturing process of a semiconductor substrate (wafer), generally, an ingot obtained by crystal growth is shaped into a cylindrical shape, a crystal orientation is identified by X-ray analysis, and then an orientation flat or a notch that is a mark indicating the crystal orientation is formed. Then, this ingot is thinly sliced using a wire saw to obtain a substrate (wafer) (see JP H09-262826 A).

However, since an orientation flat or a notch is shaped to cut into a wafer in a radial center direction, a device area is reduced and thus the number of device chips that can be produced from one semiconductor substrate (wafer) is reduced, resulting in poor productivity.

### SUMMARY

A method according to one aspect of the present disclosure is of manufacturing a substrate from an ingot having a cylindrical shape, the ingot having a first surface, a second surface on an opposite side of the first surface, and a side surface continuous with an outer rim of the first surface and an outer rim of the second surface. The method includes: relatively rotating the ingot and measurement light about a rotation axis passing through a center of the ingot while irradiating the side surface of the ingot with the measurement light, and detecting a position of a flat surface formed on the side surface of the ingot based on a change in an amount of measurement light received reflected by the side surface; forming a separation layer inside the ingot by positioning, inside the ingot, a focal point of a laser beam having a wavelength that passes through a material constituting the ingot and by relatively moving the ingot and the focal point in a predetermined direction; and after the forming of the separation layer, separating the substrate from the ingot starting from the separation layer. The forming of the separation layer includes determining the predetermined direction that is a relative moving direction of the ingot and the focal point, based on the detected position of the flat surface.

### BRIEF DESCRIPTION OF THE DRAWINGS

FIG. 1 is a perspective view illustrating an example of an ingot used in a substrate manufacturing method according to a first embodiment;

FIG. 2 is a top view illustrating the ingot in FIG. 1;

FIG. 3 is a cross-sectional view illustrating the ingot in FIG. 1;

FIG. 4 is a flowchart illustrating a processing procedure of the substrate manufacturing method according to the first embodiment;

FIG. 5 is a top view illustrating a crystal orientation measuring step in FIG. 4;

FIGS. 6A-6E are plan views illustrating the crystal orientation measuring step in FIG. 4;

FIG. 7 is a perspective view illustrating a first example of a mark forming step in FIG. 4;

FIG. 8 is a perspective view illustrating a second example of the mark forming step in FIG. 4;

FIG. 9 is a perspective view illustrating a detecting step in FIG. 4;

FIG. 10 is a perspective view illustrating a separation layer forming step in FIG. 4;

FIG. 11 is a top view illustrating the separation layer forming step in FIG. 4;

FIG. 12 is a cross-sectional view illustrating a separating step in FIG. 4;

FIG. 13 is a cross-sectional view illustrating the separating step in FIG. 4;

FIG. 14 is a perspective view illustrating a substrate manufacturing method according to a second embodiment;

FIG. 15 is a flowchart illustrating a processing procedure of the substrate manufacturing method according to the second embodiment;

FIG. 16 is a top view illustrating an external shaping step in FIG. 15; and

FIG. 17 is a perspective view illustrating the external shaping step in FIG. 15.

### DETAILED DESCRIPTION

Modes (embodiments) for carrying out the present invention will be described in detail with reference to the drawings. The present disclosure is not limited by the content described in the following embodiments. In addition, components described below include those that can be easily assumed by those skilled in the art and those that are substantially the same. Furthermore, configurations described below can be appropriately combined. In addition, various omissions, substitutions, or changes in the configuration can be made without departing from the gist of the present invention.

### First Embodiment

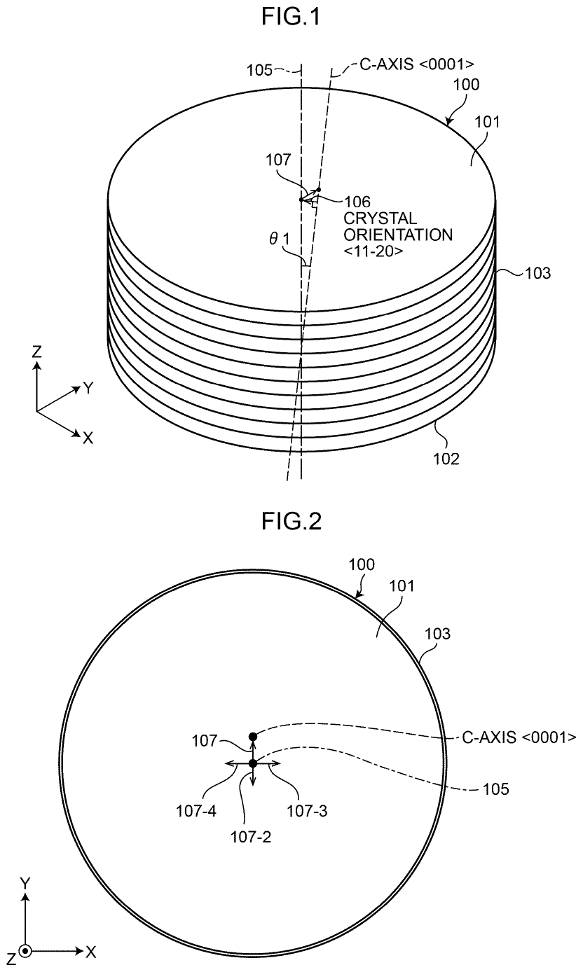

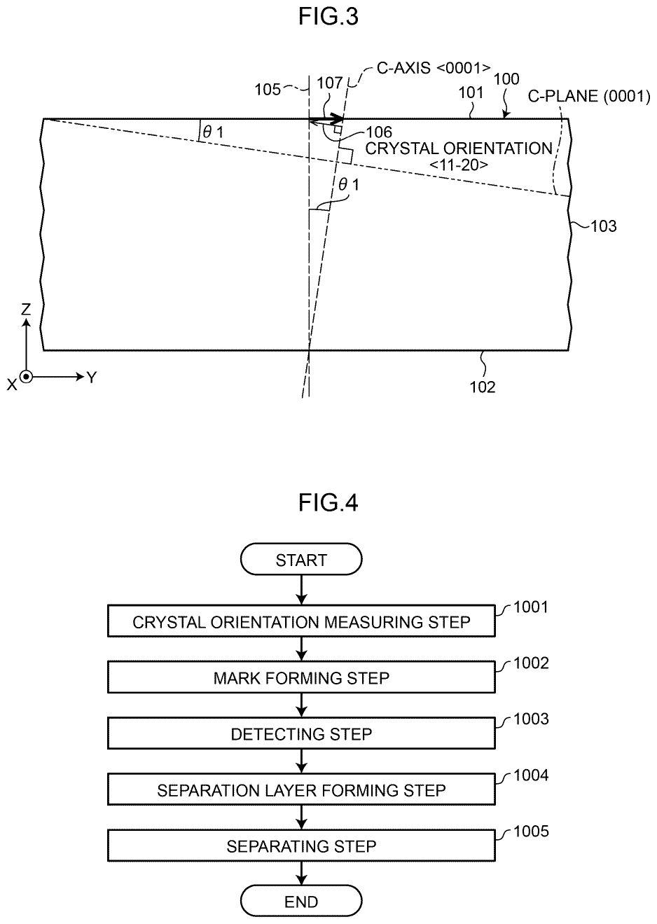

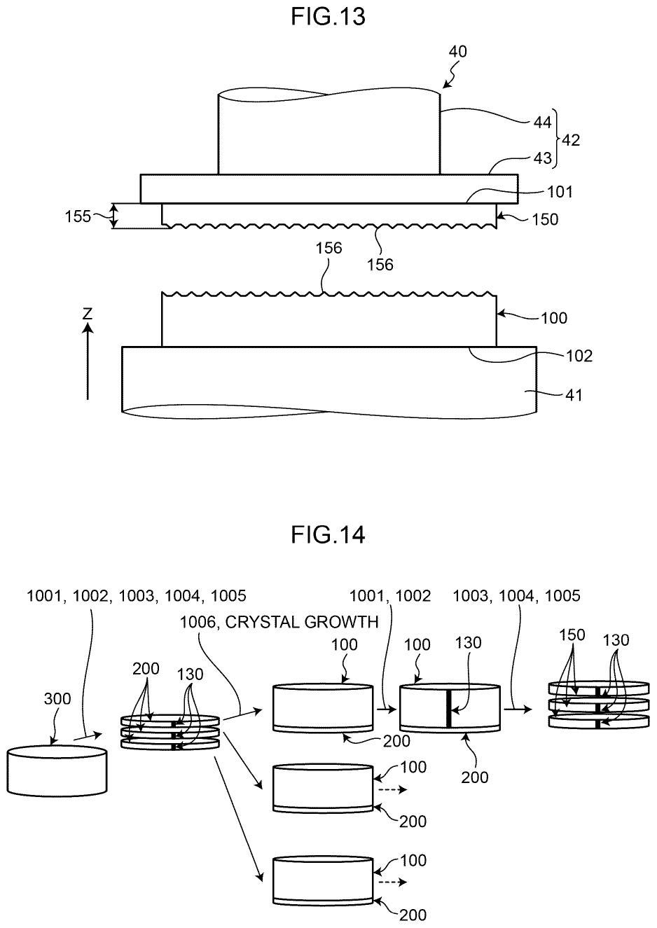

A substrate manufacturing method according to a first embodiment of the present disclosure will be described with reference to the drawings. FIG. 1 is a perspective view illustrating an example of an ingot 100 used in the substrate manufacturing method according to the first embodiment. FIG. 2 is a top view illustrating the ingot 100 in FIG. 1. FIG. 3 is a cross-sectional view illustrating the ingot 100 in FIG. 1. The substrate manufacturing method according to the first embodiment is a method of manufacturing a substrate (wafer) 150 (see FIGS. 13 and 14) from the ingot 100 as illustrated in FIG. 1, and is a method of forming the substrate 150 by slicing the ingot 100.

As illustrated in FIG. 1, the ingot 100 is a cylindrical ingot formed in a cylindrical shape as a whole. The ingot 100 has a flat circular first surface 101 exposed upward, a flat circular second surface 102 exposed downward on an opposite side of the first surface 101, and a side surface 103 located between the first surface 101 and the second surface 102 and continuous with an outer rim of the first surface 101 and an outer rim of the second surface 102. The ingot 100 is, for example, a cylindrical single crystal ingot containing silicon (Si), silicon carbide (SiC), gallium nitride (GaN), lithium tantalate (LT), lithium niobate (LN), gallium oxide (Ga2O3), gallium arsenide (GaAs), or other semiconductor components.

In the first embodiment, the ingot 100 is a hexagonal single crystal ingot made of SiC, and as illustrated in FIGS. 1, 2, and 3, the ingot 100 is produced from a seed crystal 200 (see FIG. 14 and the like) using step-controlled epitaxial growth, so that a c-axis (crystal orientation <0001>) of single crystal SiC is slightly inclined with respect to a perpendicular line 105 of the first surface 101 and the second surface 102. For example, an off angle θ1 (see FIGS. 1 and 3) formed by the c-axis and the perpendicular line 105 is 1° to 6° (typically, 4°). An off-angle direction 106 (see FIGS. 1 and 3) that is perpendicular to the c-axis and is a direction in which the perpendicular line 105 is inclined with respect to the c-axis is a direction of a predetermined crystal orientation (typically, crystal orientation <11-20>). As illustrated in FIGS. 1 and 3, the ingot 100 manufactured through a crystal growth process such as the step-controlled epitaxial growth has a minute uneven shape on the side surface 103 before external shaping is performed.

In the present specification, for convenience of description, as illustrated in FIGS. 1 and 3, a direction in which the c-axis is inclined with respect to the perpendicular line 105 on the first surface 101 is referred to as an inclination direction 107. The inclination direction 107 is calculated based on the off angle θ1 and the off-angle direction 106. As illustrated in FIG. 2, a direction opposite to the inclination direction 107 with respect to the position of the perpendicular line 105 on the first surface 101 is defined as a direction 107-2, and two directions perpendicular to the inclination direction 107 with respect to the position of the perpendicular line 105 on the first surface 101 are defined as a direction 107-3 and a direction 107-4, respectively.

Next, in the present specification, the substrate manufacturing method according to the first embodiment will be described with reference to the drawings. FIG. 4 is a flowchart illustrating a processing procedure of the substrate manufacturing method according to the first embodiment. As illustrated in FIG. 4, the substrate manufacturing method according to the first embodiment includes a detecting step 1003, a separation layer forming step 1004, and a separating step 1005.

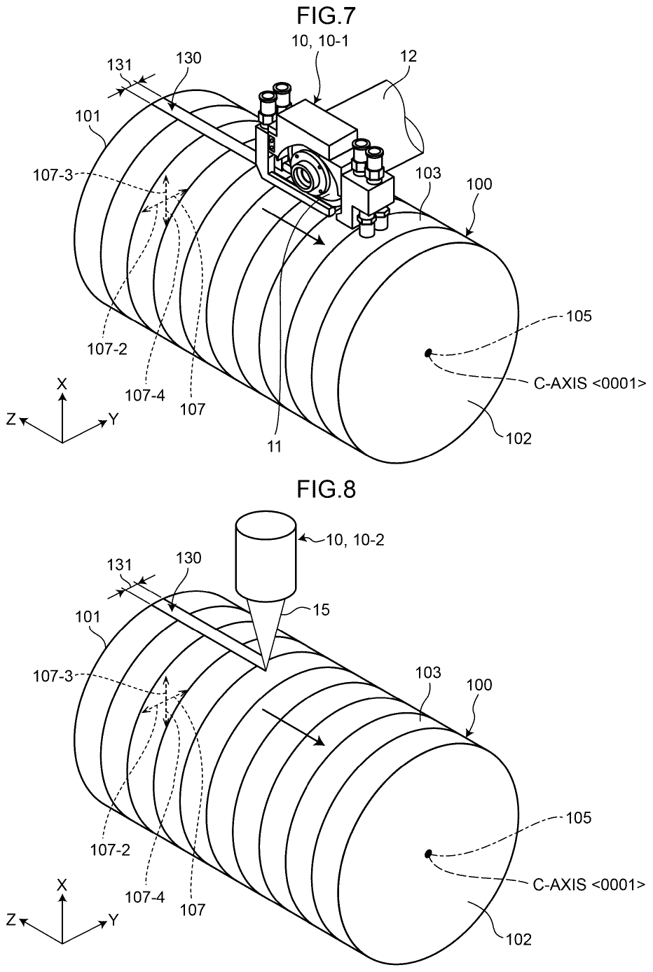

As illustrated in FIG. 4, the substrate manufacturing method according to the first embodiment may further perform a crystal orientation measuring step 1001 and a mark forming step 1002 before performing the detecting step 1003, so as to form a flat surface 130 (see FIGS. 7 to 11) to be detected in the detecting step 1003. The first embodiment describes a mode of performing the crystal orientation measuring step 1001 and the mark forming step 1002. However, the present disclosure is not limited thereto, and these steps may be omitted when the flat surface 130 is already formed.

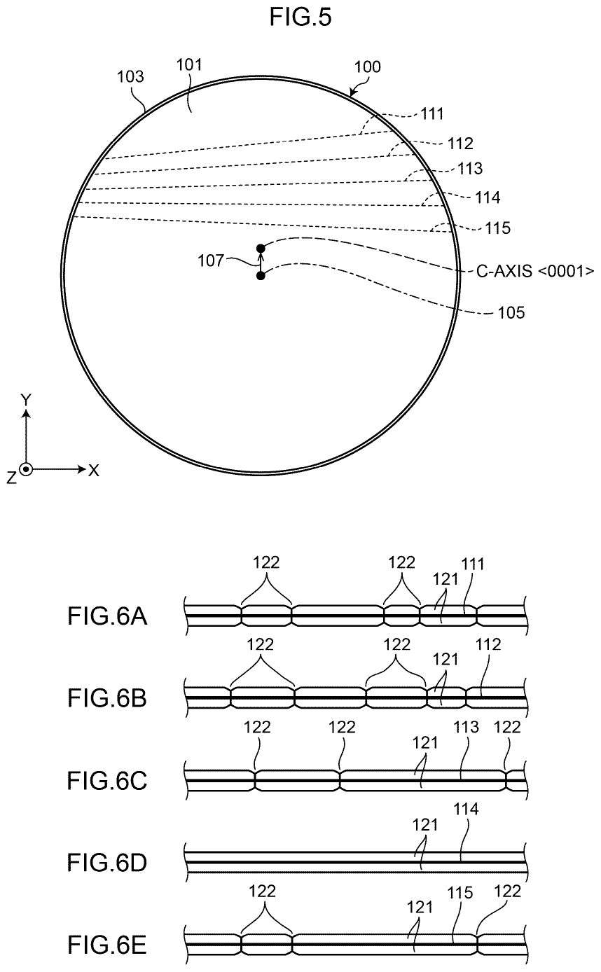

FIGS. 5 and 6A-6E are a top view and plan views, respectively, illustrating the crystal orientation measuring step 1001 in FIG. 4. As illustrated in FIGS. 5 and 6A-6E, the crystal orientation measuring step 1001 is a step of measuring characteristics related to the crystal orientation of the ingot 100.

In the first embodiment, the crystal orientation measuring step 1001 can be performed using a measurement apparatus (not illustrated) including a laser irradiator that irradiates one surface of the ingot 100 with a laser beam having a wavelength that passes through the ingot 100, a holding table that holds the other surface of the ingot 100, an observation unit that observes the one surface of the ingot 100 irradiated with the laser beam, and a control unit (computer system) that controls the laser irradiator, the holding table, and the observation unit and executes computer processing such as determination and calculation based on a result of observation by the observation unit.

In the crystal orientation measuring step 1001 of the first embodiment, first, the laser irradiator irradiates the vicinity of the one surface in the ingot 100 with the laser beam having the wavelength that passes through the ingot 100 in a plurality of directions parallel to a horizontal plane to form linear modified layers 111, 112, 113, 114, and 115 in the plurality of directions as illustrated in FIG. 5.

Here, in the crystal orientation measuring step 1001, irradiation conditions of the laser irradiator are, for example, a wavelength of the laser beam of 1064 nm, a repetition frequency of 80 kHz, an average output of 3.2 W, a pulse width of 3 ns, a focal spot diameter of φ 10 μm, a numerical aperture (NA) of a condenser lens of 0.65, a processing feed speed of 150 mm/s, and defocus of 90 μm, whereby the modified layers 111, 112, 113, 114, and 115 can be suitably formed.

In addition, in irradiation of the laser beam in the crystal orientation measuring step 1001, the one surface is the first surface 101 in the example illustrated in FIG. 5. However, the present disclosure is not limited thereto, and the one surface may be the second surface 102. Further, in the first embodiment, for example, the plurality of directions are set at an interval of predetermined angle (e.g., 0.5 degrees). Further, the modified layer is, for example, a layered region in which density, refractive index, mechanical strength, and other physical characteristics are different from those of surroundings.

In the irradiation of the laser beam in the crystal orientation measuring step 1001, specifically, first, the focal point of the laser beam is positioned in the vicinity of the first surface 101 in the ingot 100 held by the holding table at a position, for example, lower than the first surface 101 of the ingot 100 by a predetermined depth. Next, for example, the modified layer 111 is formed by linearly scanning the focal point of the laser beam while irradiating the ingot 100 with the laser beam having a wavelength that passes through the ingot 100. Then, a direction of scanning the focal point of the laser beam is slightly changed (by a predetermined angle), and the ingot 100 is similarly irradiated with the laser beam to sequentially form the linear modified layers 112, 113, 114, and 115.

In the linear modified layers 111, 112, 113, 114, and 115 formed in this way in the crystal orientation measuring step 1001, it is considered that a crack region 121 in which a crack extends along a c-plane (crystal plane (0001)) of the ingot 100 from both sides of the modified layers 111, 112, 113, 114, and 115 is formed, as illustrated in FIGS. 6A, 6B, 6C, 6D and 6E, and a node 122 of the crack region 121 is formed at positions across a plurality of c-planes.

Therefore, in the crystal orientation measuring step 1001, in the first embodiment, as illustrated in FIGS. 6A-6E, these linear modified layers 111, 112, 113, 114, and 115 previously formed are observed by the observation unit. In the crystal orientation measuring step 1001, the control unit measures characteristics related to the crystal orientation of the ingot 100 based on the number of nodes 122 observed around a predetermined length (e.g., 10 mm) of the modified layers 111, 112, 113, 114, and 115. In the crystal orientation measuring step 1001, as the number of nodes 122 observed decreases, it is determined that the scanning direction of the focal point when the modified layer is formed is close to parallel to the c-plane (angle formed with the c-plane is small).

In the crystal orientation measuring step 1001, as illustrated in FIG. 6D specifically, it is determined that a direction of scanning the focal point is parallel to the c-plane at forming the modified layer 114 when the number of observed nodes 122 is zero. In addition, as illustrated in FIGS. 6C and 6E, it is determined that the direction of scanning the focal point is close to parallel to the c-plane at forming the modified layers 113 and 115 when the number of observed nodes 122 is relatively small (three points per predetermined length in examples illustrated in FIGS. 6C and 6E). In addition, in the crystal orientation measuring step 1001, as illustrated in FIGS. 6A and 6B, it is determined that the direction of scanning the focal point is far from parallel to the c-plane (angle formed with the c-plane is large) at forming the modified layers 113 and 115 when the number of observed nodes 122 is relatively large (five points per predetermined length in examples illustrated in FIGS. 6A and 6B).

In the crystal orientation measuring step 1001, when the modified layer 114 in which the number of observed nodes 122 is zero cannot be obtained, two modified layers 113 and 115 with a relatively small number of observed nodes 122 are selected, and a direction between extending directions of the two modified layers 113 and 115 is determined to be the direction parallel to the c-plane.

In the crystal orientation measuring step 1001, a direction parallel to the c-plane on the first surface 101 is thus acquired by the control unit. Here, a direction parallel to the c-plane on the first surface 101 is a direction perpendicular to the off-angle direction 106. Therefore, in the crystal orientation measuring step 1001, the off-angle direction 106 is calculated and acquired by the control unit based on the acquired direction parallel to the c-plane on the first surface 101 and the off angle θ1 known in advance. In the crystal orientation measuring step 1001, the control unit calculates and acquires the inclination direction 107 based on the off-angle direction 106 and the off angle θ1 known in advance. The direction parallel to the c-plane on the first surface 101, the off-angle direction 106, and the inclination direction 107 are all examples of the characteristics related to the crystal orientation of the ingot 100 according to the present disclosure. In addition, one of the direction 107-2, the direction 107-3, and the direction 107-4 may be calculated and acquired together with the inclination direction 107 or instead of the inclination direction 107.

In the crystal orientation measuring step 1001 of the first embodiment, a direction of the crystal orientation of the ingot 100 is measured by observing the number of nodes 122 of the linear modified layers 111, 112, 113, 114, and 115 formed by irradiating the ingot 100 with the laser beam having the wavelength that passes through the ingot 100 in the plurality of directions. Therefore, in the crystal orientation measuring step 1001 of the first embodiment, a large-scale and expensive measuring device is unnecessary as compared with a known method such as an X-ray diffraction method. Thus, it is possible to suppress the possibility of lowering the productivity of the substrate 150 (see FIGS. 13 and 14). Note that the crystal orientation measuring step 1001 is not limited thereto in the present disclosure, and the direction of the crystal orientation of the ingot 100 may be measured by a known method such as the X-ray diffraction method.

FIGS. 7 and 8 are perspective views illustrating a first example and a second example of the mark forming step 1002 in FIG. 4, respectively. As illustrated in FIGS. 7 and 8, the mark forming step 1002 is a step of forming a mark indicating the crystal orientation on the ingot 100 based on the characteristics measured in the crystal orientation measuring step 1001.

In the mark forming step 1002, specifically, first, a position and a region where the flat surface 130 will be formed on the side surface 103 of the ingot 100 are determined based on the inclination direction 107 and the directions 107-2, 107-3, and 107-4 measured in the crystal orientation measuring step 1001. In the mark forming step 1002 in the examples of the first embodiment illustrated in FIGS. 7 and 8, it is determined that the flat surface 130 perpendicular to the direction 107-3 is formed in a region extending in a direction of the perpendicular line 105 in the direction 107-3 with respect to the perpendicular line 105 on the side surface 103 of the ingot 100. Note that, in the mark forming step 1002, the present disclosure is not limited thereto, and the flat surface 130 perpendicular to the inclination direction 107, the direction 107-2, and the direction 107-4 may be formed in a region extending in the direction of the perpendicular line 105 in any of the inclination direction 107, the direction 107-2, and the direction 107-4 with respect to the perpendicular line 105 on the side surface 103 of the ingot 100. In addition, the flat surface 130 may be formed in two or more regions among the above-described four regions on the side surface 103 of the ingot 100.

In the mark forming step 1002, next, the position and region where the flat surface 130 is to be formed on the side surface 103 of the ingot 100 determined in advance are machined into a flat planar shape perpendicular to the direction 107-3 by a mark forming device 10 (cutting device 10-1 and laser processing device 10-2) that forms a mark indicating the crystal orientation on the ingot 100, thereby forming the flat surface 130. Since the flat surface 130 formed in this manner is formed based on the characteristics related to the crystal orientation of the ingot 100, it corresponds to a mark indicating the crystal orientation of the ingot 100 in the present disclosure.

In the mark forming step 1002, the flat surface 130 is formed in a region in the direction 107-3 or the direction 107-4 with respect to the perpendicular line 105 on the side surface 103 of the ingot 100, so that the flat surface 130 can be formed in the direction of the crystal orientation <1-100> from the center. The flat surface 130 thus formed is formed in the direction of the crystal orientation <1-100> from the center also in the substrate 150 (see FIGS. 13 and 14) obtained by performing the separating step 1005 later.

In addition, in the mark forming step 1002, by forming the flat surface 130 in a region in the inclination direction 107 or the direction 107-2 with respect to the perpendicular line 105 on the side surface 103 of the ingot 100, the flat surface 130 can be formed in a direction of the crystal orientation <11-20> from the center. The flat surface 130 thus formed is formed in the direction of the crystal orientation <11-20> from the center also in the substrate 150 obtained by performing the separating step 1005 later.

In the mark forming step 1002, the flat surface 130 may be formed in any direction on the side surface 103 of the ingot 100. However, it is preferable to form the flat surface 130 in the direction of the crystal orientation <1-100> or the crystal orientation <11-20> from the center based on the specific off-angle direction 106 as in the first embodiment. By forming the flat surface 130 in this manner, the flat surface 130 formed can be formed in the direction of the crystal orientation <1-100> or the crystal orientation <11-20> from the center in the substrate 150 obtained by performing the separating step 1005 later.

In the mark forming step 1002, in the first example, as illustrated in FIG. 7, the flat surface 130 is formed using the cutting device 10-1 including a cutting blade 11 and a spindle 12. The cutting blade 11 is attached to a tip of the spindle 12 and is rotated by the spindle 12 that serves as a rotation axis to cut the side surface 103 of the ingot 100 to form the flat surface 130.

The cutting blade 11 is, for example, a cutting grindstone having an annular cutting edge in which abrasive grains such as diamond or cubic boron nitride (CBN) are fixed with a bonding material (binding material) such as metal or resin and formed to have a predetermined thickness thicker than a width 131 of the flat surface 130 to be formed. The cutting blade 11 may be a hubless blade or a hub blade in which an annular cutting edge is fixed to an outer periphery of an annular hub. In the first embodiment, the cutting edge of the cutting blade 11 has a flat peripheral surface. Here, the cutting edge of the cutting blade 11 being formed flat means that the cutting edge of the cutting blade 11 is formed to have a rectangular cross-sectional shape in a radial direction of the cutting edge in the entire circumferential direction of the cutting edge. In other words, an outer peripheral end surface is flat and an edge is close to a right angle.

In the mark forming step 1002 in the first example, as illustrated in FIG. 7, the cutting blade 11 and the ingot 100 are relatively moved in the direction of the perpendicular line 105 in a state that the cutting blade 11 to which rotation is applied by the spindle 12 is cut into a predetermined cutting depth at a position in a predetermined region of the side surface 103 of the ingot 100. In this manner, the side surface 103 of the ingot 100 is cut by the rotating cutting blade 11 into a flat planar shape perpendicular to the direction 107-3 according to an outer peripheral end surface of the cutting edge of the cutting blade 11 having a flat machining surface, thereby forming the flat surface 130.

In the mark forming step 1002 in the second example, as illustrated in FIG. 8, the flat surface 130 is formed using the laser processing device 10-2 that performs so-called ablation of sublimating or evaporating the ingot 100 by irradiating the ingot 100 with a laser beam 15 having a wavelength that has absorbability to the ingot 100.

In the mark forming step 1002 in the second example, as illustrated in FIG. 8, while the side surface 103 of the ingot 100 is irradiated with the laser beam 15 by the laser processing device 10-2, the irradiation position of the laser beam 15 is scanned in a predetermined region of the side surface 103 of the ingot 100, and the region is ablated so as to have a flat planar shape perpendicular to the direction 107-3 to form the flat surface 130. Depending on the width 131 of the flat surface 130 to be formed, a focal spot diameter of the laser beam 15 and an intensity distribution of the laser beam 15 in the direction of the width 131 of the flat surface 130 may be adjusted, and the irradiation position of the laser beam 15 may be linearly scanned in the direction of the perpendicular line 105 to form the flat surface 130.

In the mark forming step 1002, the flat surface 130 is formed from the side of the first surface 101 toward the side of the second surface 102 of the ingot 100 in the examples of the first embodiment illustrated in FIGS. 7 and 8. However, the present disclosure is not limited thereto, and the flat surface 130 may be formed from the side of the second surface 102 toward the side of the first surface 101 of the ingot 100, or the flat surface 130 may be formed from between the first surface 101 and the second surface 102 of the ingot 100.

In addition, in the mark forming step 1002 in the first embodiment, the flat surface 130 is formed by cutting using the cutting device 10-1 illustrated in FIG. 7 or by ablation using the laser processing device 10-2 illustrated in FIG. 8. However, the present disclosure is not limited thereto. Alternatively, the flat surface 130 may be formed by grinding using a grinding wheel of a grinding device or by polishing using a polishing pad of a polishing device.

In the mark forming step 1002, for example, when an outer diameter of the ingot 100 is about φ 200 mm, the side surface 103 of the ingot 100 is machined radially inward by about 0.3 mm to form the flat surface 130 having the width 131 of about 22 mm. On the other hand, conventionally, for example, in the case of an ingot having a similar size, an orientation flat is formed by machining a side surface of the ingot radially inward by about 2 mm to 3 mm, and a notch is formed by machining a side surface of the ingot radially inward by about 1.5 mm. Therefore, in the first embodiment in which the flat surface 130 is formed, it is possible to greatly suppress an amount of radially inward machining of the side surface 103 of the ingot 100 as compared with the case of forming the conventional orientation flat or notch. As a result, in the first embodiment in which the flat surface 130 is formed, it is possible to greatly suppress a decrease in the device area where the device such as a semiconductor device or an optical device is formed in the substrate 150 (see FIGS. 13 and 14) manufactured from the ingot 100, as compared with the case of forming the conventional orientation flat or notch. Thus, it is possible to greatly suppress the possibility that productivity deteriorates due to a decrease in the number of device chips that can be produced from one substrate 150.

The flat surface 130 formed in the mark forming step 1002 indicates a predetermined crystal orientation of the ingot 100. Therefore, the flat surface 130 can be used as a mark for identifying the crystal orientation of the ingot 100 by emitting light and receiving reflected light to detect the flat surface 130 in the detecting step 1003 described later. The flat surface 130 continues to have same properties also in the substrate 150 obtained by performing the separating step 1005. Since the flat surface 130 has the above properties, it is also referred to as an orientation mirror (ORIMIRROR (registered trademark No. 4984358 of DISCO Corporation)).

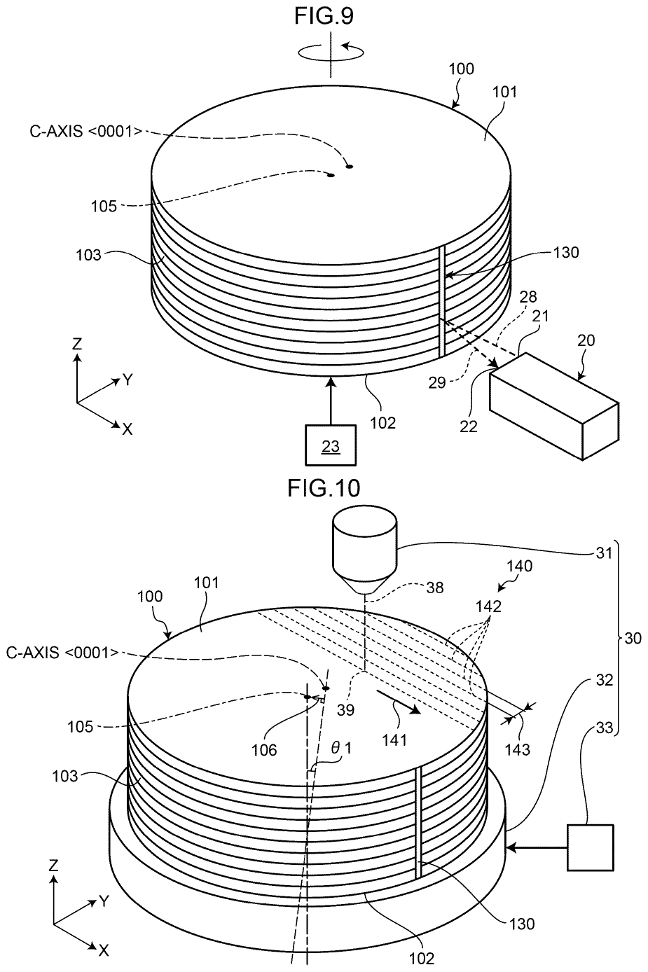

FIG. 9 is a perspective view illustrating the detecting step 1003 in FIG. 4. As illustrated in FIG. 9, the detecting step 1003 is a step of relatively rotating the ingot 100 and measurement light 28 about the rotation axis passing through the center of the ingot 100 while irradiating the side surface 103 of the ingot 100 with the measurement light 28, and detecting the position of the flat surface 130 formed on the side surface 103 of the ingot 100 based on a change in an amount of measurement light 29 received reflected by the side surface 103. In the detecting step 1003, the position of the flat surface 130 formed on the side surface 103 of the ingot 100 in the radial direction of the ingot 100 is detected.

The position of the flat surface 130 detected in the detecting step 1003 is used in the next separation layer forming step 1004. Therefore, the detecting step 1003 is preferably performed in a state that the ingot 100 is held on the holding table 32 (see FIG. 10) of the laser processing device 30 (see FIG. 10) for performing the separation layer forming step 1004. In this case, the position of the flat surface 130 detected in the detecting step 1003 can be suitably used in the next separation layer forming step 1004. In the detecting step 1003 in the first embodiment, the position of the flat surface 130 is detected with respect to the ingot 100 whose other surface (second surface 102) is held on the holding table 32 and one surface (first surface 101) is directed upward.

In the detecting step 1003 in the first embodiment, as illustrated in FIG. 9, the position of the flat surface 130 formed in the mark forming step 1002 is detected using a detector 20. The detector 20 includes a light projecting unit 21, a light receiving unit 22, a rotation mechanism 23, and a control unit (computer system) (not illustrated) that controls the light projecting unit 21, the light receiving unit 22, and the rotation mechanism 23.

The light projecting unit 21 irradiates the side surface 103 or the flat surface 130 formed on the side surface 103 of the ingot 100 with the measurement light 28. The light projecting unit 21 emits the measurement light 28, and the light receiving unit 22 receives the measurement light 29 that is the measurement light 28 reflected by the side surface 103 or the flat surface 130 formed on the side surface 103 of the ingot 100. The light projecting unit 21 and the light receiving unit 22 are provided adjacent to each other so as to have the same optical axis direction.

When a region where the flat surface 130 is not formed on the side surface 103 of the ingot 100 is located in the optical axis direction of the light projecting unit 21 and the light receiving unit 22, the measurement light 28 emitted from the light projecting unit 21 is scattered in various directions due to a minute uneven shape of the side surface 103. Thus, the light receiving unit 22 receives a very small amount of the measurement light 29 compared to the irradiation amount of the measurement light 28. On the other hand, as illustrated in FIG. 9, when the flat surface 130 formed on the side surface 103 of the ingot 100 is located in the optical axis direction of the light projecting unit 21 and the light receiving unit 22, the measurement light 28 emitted from the light projecting unit 21 is almost completely reflected by the flat surface 130, and thus the light receiving unit 22 receives a large amount of the measurement light 29 that is almost the same as the irradiation amount of the measurement light 28.

The rotation mechanism 23 rotates the ingot 100 around the perpendicular line 105, which is the rotation axis passing through the center of the ingot 100, relatively to the light projecting unit 21 and the light receiving unit 22. The rotation mechanism 23 is, for example, a motor, and is connected to a motor driver that supplies driving power to the motor. The motor driver includes an encoder that reads a rotational position of the motor, and detects a rotation speed of the motor based on a temporal change in the rotational position of the motor read by the encoder. The motor driver controls the driving power supplied to the motor to control the rotation speed of the motor to be detected. The motor driver is electrically connected to the control unit of the detector 20 so as to be able to communicate information, is controlled by the control unit, and outputs the rotational position and the rotation speed of the motor to the control unit of the detector 20.

In the first embodiment, the detector 20 that executes the detecting step 1003 may further include a height adjustment mechanism that can adjust relative heights of the holding table 32 (see FIG. 10) that holds the ingot 100, and the light projecting unit 21 that emits the measurement light 28 and the light receiving unit 22 that receives the measurement light 29. In the detecting step 1003, the height in the direction of the perpendicular line 105 of the ingot 100 for detecting the position of the flat surface 130 can be changed by the height adjustment mechanism. In the detecting step 1003, the height adjustment mechanism may be used to detect the position of the flat surface 130 at one desired height in the direction of the perpendicular line 105 of the ingot 100, or detect the position of the flat surface 130 at a plurality of heights.

In addition, the height adjustment mechanism performs a preferable function particularly when the thickness of the ingot 100 is reduced by repeating separation of the substrate 150 (see FIGS. 13 and 14). In the detecting step 1003, the height adjustment mechanism changes the height of the ingot 100 in the direction of the perpendicular line 105 for detecting the position of the flat surface 130 according to the thickness of the ingot 100. Thus, in a direction determining step of the separation layer forming step 1004 to be performed later, there is an effect that it is possible to execute alignment every time to identify an accurate machining direction (predetermined direction 141). The thickness of the ingot 100 is a length in the direction of the perpendicular line 105 of the ingot 100, and corresponds to a distance between the first surface 101 and the second surface 102.

The control unit of the detector 20 acquires information on a direction of the ingot 100 rotated by the rotation mechanism 23 based on the rotational position of the motor acquired from the motor driver of the rotation mechanism 23. As a result, the control unit of the detector 20 can acquire information on a region on the side surface 103 of the ingot 100 located in the optical axis direction of the light projecting unit 21 and the light receiving unit 22.

In the detecting step 1003 in the first embodiment, as illustrated in FIG. 9, the detector 20 emits the measurement light 28 by the light projecting unit 21 and receives the measurement light 29 by the light receiving unit 22 while rotating the ingot 100 around the perpendicular line 105 by the rotation mechanism 23. Here, the perpendicular line 105 of the ingot 100 corresponds to the rotation axis passing through the center of the ingot 100 in the present disclosure. As a result, the detector 20 acquires information on the temporal change of the amount of measurement light 29 received by the light receiving unit 22 and information on the temporal change of the region on the side surface 103 of the ingot 100 located in the optical axis direction of the light projecting unit 21 and the light receiving unit 22. In these pieces of information on the temporal change, the change in the amount of measurement light 29 received by the light receiving unit 22 and the change in the region on the side surface 103 of the ingot 100 located in the optical axis direction of the light projecting unit 21 and the light receiving unit 22 are compared with each other through the information on the temporal change.

In the detecting step 1003, the detector 20 detects, as the position of the flat surface 130 formed on the side surface 103 of the ingot 100, a region on the side surface 103 of the ingot 100 located in the optical axis direction of the light projecting unit 21 and the light receiving unit 22, corresponding to the case where the amount of measurement light 29 received by the light receiving unit 22 is maximized based on the change in the amount of measurement light 29 received.

In the first embodiment, the detecting step 1003 may detect the position of the flat surface 130 in two steps, including a first detecting step of roughly measuring the position of the flat surface 130 in the entire circumference of the side surface 103 of the ingot 100 at a predetermined height, and a second detecting step of finely measuring the position of the flat surface 130 by more finely measuring around the region where the amount of measurement light 29 received becomes remarkably large and maximized on the side surface 103 of the ingot 100. In this case, the position of the flat surface 130 can be detected more precisely.

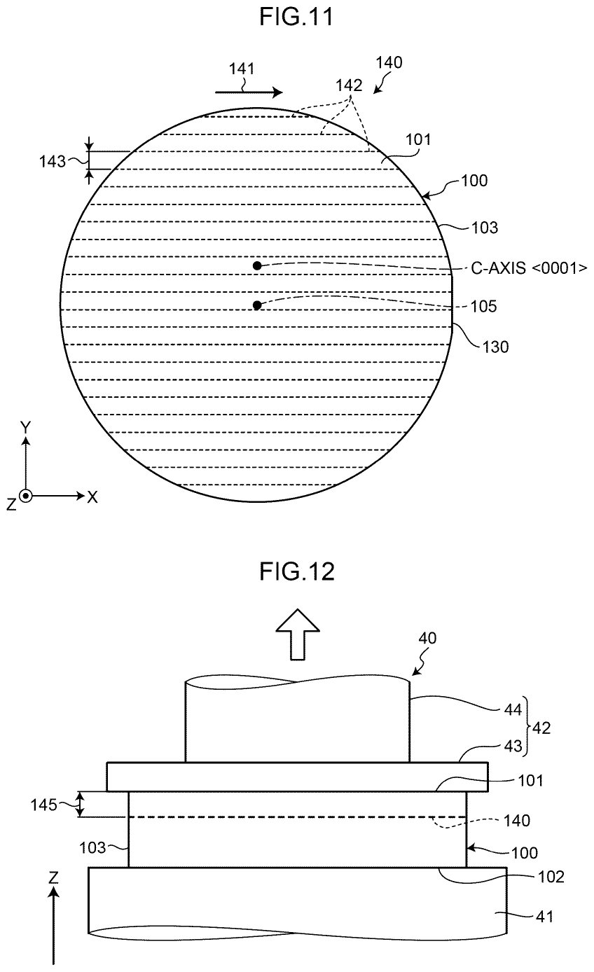

FIGS. 10 and 11 are a perspective view and a top view, respectively, illustrating the separation layer forming step 1004 in FIG. 4. The separation layer forming step 1004 in the first embodiment includes the direction determining step, a laser beam irradiating step, and an indexing and feeding step. In the separation layer forming step 1004, after performing the direction determining step to determine the predetermined direction 141, the laser beam irradiating step and the indexing and feeding step are alternately performed to form a plurality of modified layers 142 extending in the predetermined direction 141 and the separation layer 140 including cracks extending from the modified layers 142 in the ingot 100 over a plane parallel to the first surface 101.

In the separation layer forming step 1004 in the first embodiment, as illustrated in FIG. 10, the separation layer 140 is formed inside the ingot 100 using the laser processing device 30. The laser processing device 30 includes a laser irradiator 31 that irradiates the ingot 100 from one surface (first surface 101) of the ingot 100 with a laser beam 38 having a wavelength that passes through the material constituting the ingot 100, the holding table 32 that holds the ingot 100 from the other surface (second surface 102), a moving unit 33 that relatively moves the laser irradiator 31 and the holding table 32, and a control unit (computer system) (not illustrated) that controls the laser irradiator 31 and the holding table 32.

The direction determining step is a step of determining the predetermined direction 141 that is a relative moving direction between the ingot 100 and a focal point 39 of the laser beam 38, based on the position of the flat surface 130 detected in the detecting step 1003 in the separation layer forming step 1004.

Here, when the constituent material of the ingot 100 is single crystal SiC, the predetermined direction 141 is preferably a direction perpendicular to the off-angle direction 106 and parallel to the one surface (first surface 101) of the ingot 100. When the predetermined direction 141 is set in this manner, cracks extend from the linear modified layers 142 formed in the laser beam irradiating step of the separation layer forming step 1004 in the direction perpendicular to the predetermined direction 141, so that the modified layers 142 formed in parallel and adjacent to each other are likely to be connected to each other by the cracks extended. This makes it possible to suitably form the separation layer 140 that can be suitably separated in the separating step 1005 to be performed later.

Therefore, in the direction determining step, the off-angle direction 106 is acquired based on the position of the flat surface 130 detected in the detecting step 1003, and the predetermined direction 141 is determined in a direction perpendicular to the off-angle direction 106 and parallel to the one surface (first surface 101) of the ingot 100 based on the off-angle direction 106 acquired. In the direction determining step, based on the position of the flat surface 130 detected in the detecting step 1003, alignment to position the ingot 100 with the focal point 39 of the laser beam 38 irradiated by the laser irradiator 31 in the laser beam irradiating step is performed, and the laser processing device 30 is set so that the ingot 100 and the focal point 39 can be relatively moved in the predetermined direction 141 in the laser beam irradiating step.

As illustrated in FIGS. 10 and 11, the laser beam irradiating step is a step of forming one modified layer 142 extending in the predetermined direction 141 and a crack extending from the modified layer 142 by positioning, inside the ingot 100, the focal point 39 of the laser beam 38 having a wavelength that passes through the material constituting the ingot 100 and relatively moving the ingot 100 and the focal point 39 in the predetermined direction 141 determined based on the position of the flat surface 130 detected in the detecting step 1003.

In the laser beam irradiating step, first, the focal point 39 of the laser beam 38 irradiated by the laser irradiator 31 is positioned at a depth 145 (see FIG. 12) corresponding to a thickness 155 (see FIG. 13) of the substrate 150 (see FIGS. 13 and 14) manufactured from the first surface 101 of the ingot 100. Then, as illustrated in FIG. 10, while the laser irradiator 31 emits the laser beam 38 in which the focal point 39 is positioned at the above-described depth 145, the holding table 32 holding the ingot 100 and the laser irradiator 31 that emits the laser beam 38 are relatively moved in the predetermined direction 141 by the moving unit 33. Thus, one linear modified layer 142 parallel to the first surface 101 and the predetermined direction 141 and a crack extending from the modified layer 142 in a direction perpendicular to the predetermined direction 141 are formed at a position of the depth 145 from the first surface 101 inside the ingot 100.

In the indexing and feeding step, the holding table 32 holding the ingot 100 and the laser irradiator 31 emitting the laser beam 38 are relatively moved for a predetermined amount 143 in a direction parallel to the first surface 101 of the ingot 100 and perpendicular to the predetermined direction 141 by the moving unit 33, so that the position where one modified layer 142 is formed in the laser beam irradiating step is shifted for the predetermined amount 143. Here, the predetermined amount 143 is, for example, about twice an average length of the crack extending from the linear modified layer 142, and specifically, about 100 μm. By setting the predetermined amount 143 to the above-described length, cracks extending from two modified layers 142 formed adjacent to each other at an interval of the predetermined amount 143 can be connected to each other.

In the separation layer forming step 1004, after the direction determining step is performed and the predetermined direction 141 is determined, the laser beam irradiating step and the indexing and feeding step are alternately performed, so that the plurality of linear modified layers 142 parallel to the predetermined direction 141 are arranged and formed at intervals of the predetermined amount 143 over an entire plane at the depth 145 inside the ingot 100 from the first surface 101 as illustrated in FIG. 11. In the plurality of linear modified layers 142 formed in this manner, cracks extending from the adjacent modified layers 142 are connected to each other, so that the cracks are connected in the entire plane at the depth 145 inside the ingot 100 from the first surface 101 to form the separation layer 140. By applying a predetermined external force to the ingot 100, the substrate 150 having the thickness 155 (see FIG. 13) corresponding to the depth 145 (see FIG. 12) including the first surface 101 can be separated starting from the separation layer 140 formed in the separation layer forming step 1004.

FIGS. 12 and 13 are both cross-sectional views illustrating the separating step 1005 in FIG. 4. The separating step 1005 is a step of separating the substrate 150 from the ingot 100 starting from the separation layer 140 formed in the separation layer forming step 1004, as illustrated in FIGS. 12 and 13, after the separation layer forming step 1004.

The separating step 1005 is performed by a separation device 40 illustrated in FIGS. 12 and 13. As illustrated in FIGS. 12 and 13, the separation device 40 includes a holding table 41 that holds the ingot 100, a separation unit 42, and a control unit (computer system) (not illustrated) that controls the holding table 41 and the separation unit 42.

The separation unit 42 includes a suction holder 43 and a moving unit 44. The suction holder 43 is formed in a disk shape, and a lower surface of the suction holder 43 sucks and holds the first surface 101 of the ingot 100. The moving unit 44 relatively moves the holding table 41 and the suction holder 43, for example, in the Z-axis direction. The moving unit 44 can apply a force to pull the ingot 100 in the Z-axis direction by applying power to the suction holder 43 that sucks and holds the first surface 101 of the ingot 100 held on the holding table 41 in a direction relatively separating the suction holder 43 from the holding table 41 in the Z-axis direction.

In the separating step 1005, as illustrated in FIGS. 12 and 13, first, the ingot 100 is held by the holding table 41 from the second surface 102 with the first surface 101 exposed, and the first surface 101 of the ingot 100 is sucked and held by the suction holder 43 of the separation unit 42. Then, by applying a pulling force in the Z-axis direction to the ingot 100 held on the holding table 41 by the moving unit 44 of the separation unit 42, the substrate 150 having the thickness 155 including the first surface 101 is separated from the ingot 100 at a separation surface 156, starting from the separation layer 140.

In the substrate manufacturing method according to the first embodiment, an external force applying step such as insertion of a wedge or application of an ultrasonic wave may be performed after performing the separation layer forming step 1004 and before performing the separating step 1005 or simultaneously with the separating step 1005.

In the external force applying step, for example, by driving the wedge into the height position of the separation layer 140 with respect to the side surface 103 of the ingot 100, the crack of the separation layer 140 can be further extended in the direction parallel to the first surface 101. The wedge may be driven at one location, or may be driven at a plurality of locations in the circumferential direction of the ingot 100.

In the external force applying step, the crack of the separation layer 140 can be further extended in the direction parallel to the first surface 101 also by applying an ultrasonic wave (elastic vibration wave in a frequency band exceeding 20 kHz) to the ingot 100 instead of driving the wedge. In this case, in the external force applying step, the ultrasonic wave is applied to the first surface 101 via a liquid such as pure water before the first surface 101 of the ingot 100 is sucked and held by the lower surface of the suction holder 43. Specifically, in the external force applying step, the liquid to which the ultrasonic wave is applied may be sprayed toward the first surface 101 of the ingot 100, or the ultrasonic wave may be applied from an ultrasonic horn to the first surface 101 of the ingot 100 via the liquid. Furthermore, in the external force applying step, first, the ultrasonic wave is applied to a local region having a diameter of about 5 mm to 50 mm on the first surface 101 of the ingot 100, and then the region to apply the ultrasonic wave is gradually broadened, so that the crack of the separation layer 140 can be further preferably extended in the direction parallel to the first surface 101.

By performing the external force applying step, cracks are further connected between adjacent modified layers 142, and a mechanical strength of the separation layer 140 is further weakened as compared with a region without the separation layer 140 of the ingot 100. Therefore, the substrate 150 can be separated from the ingot 100 with a smaller force than when the external force applying step is not performed.

In the substrate manufacturing method according to the first embodiment, as described above, the crystal orientation measuring step 1001, the mark forming step 1002, the detecting step 1003, the separation layer forming step 1004, and the separating step 1005 are sequentially performed on the ingot 100 to manufacture the substrate 150 having the thickness 155.

In the substrate 150 manufactured as described above, a portion corresponding to the flat surface 130 formed in the ingot 100 can be used as a mark for identifying the crystal orientation of the substrate 150. In the substrate 150 manufactured as described above, for example, the separation surface 156 is ground and flattened, a plurality of splitting lines are formed in a lattice shape on one surface, and devices such as semiconductor devices or optical devices are formed in regions defined by the plurality of splitting lines, so that the substrate 150 is processed into a device substrate such as a semiconductor device substrate or an optical device substrate.

In the substrate manufacturing method according to the first embodiment having the above configuration, the ingot 100 is aligned based on the flat surface 130 that is formed on the side surface 103 of the ingot 100 and serves as a mark indicating the crystal orientation, the predetermined direction 141 that is a relative moving direction between the ingot 100 and the focal point 39 of the laser beam 38 irradiating the ingot 100 is determined, the laser beam 38 is irradiated inside the ingot 100 to form the separation layer 140, and the ingot 100 is separated starting from the separation layer 140, thereby manufacturing the substrate 150. In the substrate manufacturing method according to the first embodiment, as described above, the ingot 100 is processed based on the crystal orientation using the flat surface 130 serving as the mark indicating the crystal orientation to manufacture the substrate 150.

Therefore, the substrate manufacturing method according to the first embodiment can greatly suppress an amount of radially inward machining of the side surface 103 of the ingot 100 as compared with the case of using the conventional orientation flat or notch. As a result, the substrate manufacturing method according to the first embodiment can greatly suppress a decrease in the device area where the device such as the semiconductor device or the optical device is formed in the substrate 150 manufactured from the ingot 100, as compared with the case of using the conventional orientation flat or notch. Thus, it is possible to greatly suppress the possibility that productivity deteriorates due to a decrease in the number of device chips that can be produced from one substrate 150.

In addition, the substrate manufacturing method according to the first embodiment further includes, before performing the detecting step 1003, the crystal orientation measuring step 1001 of measuring characteristics related to the crystal orientation of the ingot 100, and the mark forming step 1002 of forming the flat surface 130 that is the mark indicating the crystal orientation of the ingot 100 on the side surface 103 of the ingot 100 based on the characteristics measured in the crystal orientation measuring step 1001. Thus, the substrate manufacturing method according to the first embodiment can more suitably achieve an effect of greatly suppressing an amount of radial inward machining of the side surface 103 of the ingot 100.

### Second Embodiment

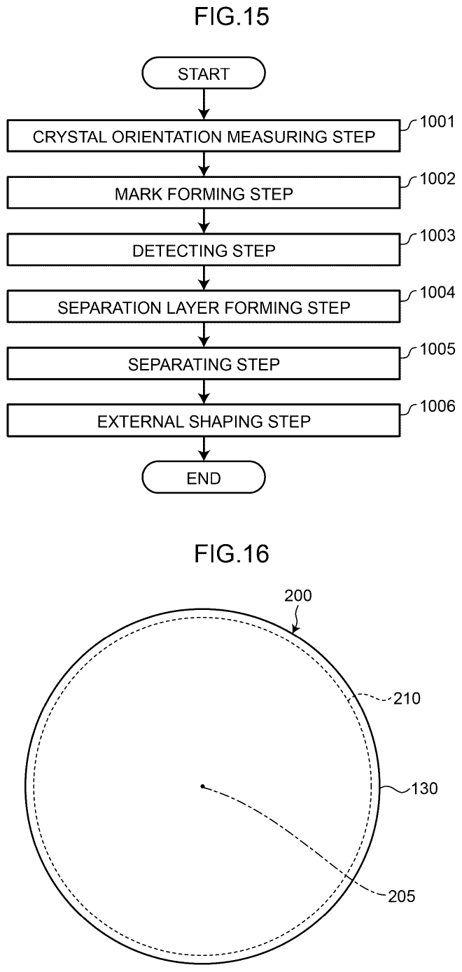

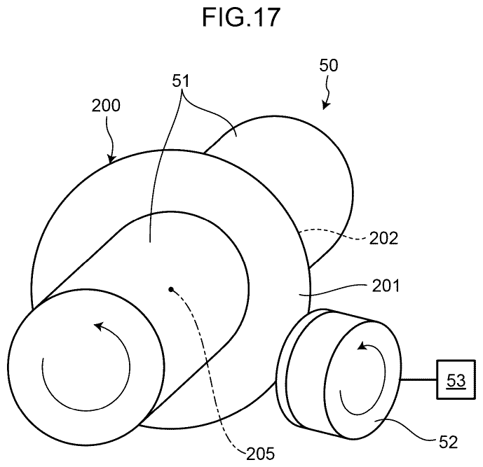

A substrate manufacturing method according to a second embodiment of the present disclosure will be described with reference to the drawings. FIG. 14 is a perspective view illustrating the substrate manufacturing method according to the second embodiment. FIG. 15 is a flowchart illustrating a processing procedure of the substrate manufacturing method according to the second embodiment. FIGS. 16 and 17 are a top view and a perspective view, respectively, illustrating an external shaping step 1006 in FIG. 15. In FIGS. 14 to 17, the same parts as those in the first embodiment are denoted by the same reference numerals, and description thereof is omitted.

The first embodiment, as illustrated on the right side of FIG. 14, has described the method of performing the crystal orientation measuring step 1001 and the mark forming step 1002 on the ingot 100 generated from the seed crystal 200 to measure the characteristics related to the crystal orientation and form the flat surface 130, and performing the detecting step 1003, the separation layer forming step 1004, and the separating step 1005 to detect the flat surface 130 formed, determine processing orientation, and form the separation layer 140, thereby manufacturing the substrate 150 by separation.

The second embodiment, as illustrated on the left side of FIG. 14, will describe a method of performing the crystal orientation measuring step 1001 and the mark forming step 1002 similar to those in the first embodiment on a seed crystal ingot 300 to measure the characteristics related to the crystal orientation and form the flat surface 130, and performing the detecting step 1003, the separation layer forming step 1004, and the separating step 1005 similar to those in the first embodiment to detect the flat surface 130 formed, determine the processing orientation, and form the separation layer 140 to manufacture the seed crystal 200 by separation. Still more, the external shaping step 1006 described later is further performed on the seed crystal 200. Here, the seed crystal ingot 300 and the seed crystal 200 in the second embodiment are examples of those corresponding to the ingot 100 and the substrate 150 in the present disclosure, respectively.

As illustrated in FIG. 15, the substrate manufacturing method according to the second embodiment is changed from the substrate manufacturing method according to the first embodiment to further include the external shaping step 1006 after performing the separating step 1005. The external shaping step 1006 does not shape the ingot 100 or the seed crystal ingot 300 into a cylindrical shape as in the conventional case. Respective steps from the crystal orientation measuring step 1001 to the separating step 1005 are performed on the seed crystal ingot 300 to obtain a substrate-like seed crystal 200, and then seed crystal 200 is shaped into a disk shape.

Since it is not essential to perform the external shaping step 1006 in the substrate manufacturing method according to the second embodiment, the present disclosure includes an embodiment in which the external shaping step 1006 is omitted and the seed crystal ingot 300 is also subjected to the same processing as the substrate manufacturing method according to the first embodiment.

The external shaping step 1006, after performing the separating step 1005, is a step of shaping the outer shape of the seed crystal 200 separated from the seed crystal ingot 300 into a circular outer shape 210 and removing the flat surface 130 as illustrated in FIGS. 16 and 17.

The external shaping step 1006 is performed by an external shaping device 50 illustrated in FIG. 17. As illustrated in FIG. 17, the external shaping device 50 includes a clamp mechanism 51 that sandwiches and holds the seed crystal 200 between a first surface 201 and a second surface 202, a cup grinding wheel 52 that grinds the outer periphery of the seed crystal 200, a moving unit 53 that relatively moves the clamp mechanism 51 and the cup grinding wheel 52, and a control unit (computer system) (not illustrated) that controls the clamp mechanism 51, the cup grinding wheel 52, and the moving unit 53. The clamp mechanism 51 is provided with a rotary drive source (not illustrated) that rotates the clamp mechanism 51 about a central axis. The cup grinding wheel 52 is provided with a rotary drive source (not illustrated) that rotates the cup grinding wheel 52 about the central axis.

In the external shaping step 1006, as illustrated in FIG. 17, first, the seed crystal 200 is sandwiched and held between the first surface 201 and the second surface 202 by the clamp mechanism 51, and the moving unit 53 positions the cup grinding wheel 52 toward the outer periphery of the seed crystal 200 held by the clamp mechanism 51. Then, the cup grinding wheel 52 grinds the outer periphery of the seed crystal 200 by rotating the clamp mechanism 51 about the central axis to rotate the seed crystal 200 about a perpendicular line 205 and pressing the cup grinding wheel 52 toward the outer periphery of the seed crystal 200 while rotating the cup grinding wheel 52 about the central axis.

In the external shaping step 1006, the cup grinding wheel 52 grinds about 50 μm radially inward in a region where the flat surface 130 is formed on the outer periphery of the seed crystal 200, and grinds about 2 mm to 3 mm radially inward in a region where the flat surface 130 is not formed on the outer periphery of the seed crystal 200. In the external shaping step 1006, the outer shape of the seed crystal 200 is thus shaped into the circular outer shape 210 illustrated in FIG. 16, and the flat surface 130 is removed.

The seed crystal 200 having a shaped outer diameter obtained by performing the external shaping step 1006 is used for producing the ingot 100 through the crystal growth process, as illustrated in FIG. 14.

In the substrate manufacturing method according to the second embodiment having the above configuration, the seed crystal 200 having the same thickness as that of the substrate 150 is manufactured by performing the crystal orientation measuring step 1001, the mark forming step 1002, the detecting step 1003, the separation layer forming step 1004, and the separating step 1005 similar to those of the first embodiment on the seed crystal ingot 300 having the same physical properties as the ingot 100. Therefore, the substrate manufacturing method according to the second embodiment has the same effects as those of the first embodiment.

The substrate manufacturing method according to the second embodiment further includes the external shaping step 1006 of shaping the outer shape of the seed crystal 200 manufactured by separation from the seed crystal ingot 300 into the circular outer shape 210 and removing the flat surface 130. Therefore, the substrate manufacturing method according to the second embodiment can further suppress the possibility that the flat surface 130 affects the subsequent crystal growth for producing the ingot 100 from the seed crystal 200.

According to the present disclosure, an ingot is aligned based on a flat surface that is formed on a side surface of the ingot and serving as a mark indicating a crystal orientation, a relative moving direction between the ingot and a focal point of a laser beam with which the ingot is irradiated is determined, a separation layer is formed by irradiating inside the ingot with the laser beam, and the ingot is separated starting from this separation layer to manufacture a substrate. Therefore, according to the present disclosure, an amount of radially inward machining of the side surface of the ingot can be greatly suppressed as compared with the case of using the conventional orientation flat or the notch. As a result, according to the present disclosure, a decrease in a device area on the substrate manufactured from the ingot can be greatly suppressed as compared with the case of using the conventional orientation flat or the notch. Thus, it is possible to greatly suppress the possibility that productivity deteriorates due to a decrease in the number of device chips that can be produced from one substrate.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of manufacturing a substrate from an ingot having a cylindrical shape, the ingot having a first surface, a second surface on an opposite side of the first surface, and a side surface continuous with an outer rim of the first surface and an outer rim of the second surface, the method comprising:
relatively rotating the ingot and measurement light about a rotation axis passing through a center of the ingot while irradiating the side surface of the ingot with the measurement light, and detecting a position of a flat surface formed on the side surface of the ingot based on a change in an amount of measurement light received reflected by the side surface;
forming a separation layer inside the ingot by positioning, inside the ingot, a focal point of a laser beam having a wavelength that passes through a material constituting the ingot and by relatively moving the ingot and the focal point in a predetermined direction; and
after the forming of the separation layer, separating the substrate from the ingot starting from the separation layer,
wherein the forming of the separation layer includes determining the predetermined direction that is a relative moving direction of the ingot and the focal point, based on the detected position of the flat surface.

2. The method of manufacturing a substrate according to claim 1, further comprising forming the flat surface, the forming of the flat surface including:
measuring a characteristic related to a crystal orientation of the ingot; and
forming a mark indicating the crystal orientation on the ingot based on the measured characteristic.

3. The method of manufacturing a substrate according to claim 1, further comprising, after the separating of the substrate, shaping an outer shape of the substrate separated from the ingot to remove the flat surface.
